(19) United States
(12) Patent Application Publication
(10) Pub. No.: US 2026/0140531 A1
(43) Pub. Date: May 21, 2026

(54) DISPLAYPORT OUTPUT ADAPTER AND METHOD FOR CONTROLLING CLOCK SIGNAL OF DISPLAYPORT OUTPUT ADAPTER

(71) Applicant: Realtek Semiconductor Corp., HsinChu (TW)

(72) Inventors: Che-Yen Lee, HsinChu (TW); Cheng-Hung Wu, HsinChu (TW)

(73) Assignee: Realtek Semiconductor Corp., HsinChu (TW)

(21) Appl. No.: 19/375,194

(22) Filed: Oct. 30, 2025

(30) Foreign Application Priority Data
Nov. 21, 2024 (TW) 113144796

(51) Int. Cl. G06F 1/04

(52) U.S. Cl. CPC G06F 1/04

(57) ABSTRACT

A DisplayPort (DP) output adapter and a method for controlling a clock signal of the DP output adapter are disclosed. The DP output adapter includes a clock generator, a storage device and a controller, wherein the storage device is coupled to the clock generator, and the controller is coupled to the clock generator and the storage device. The clock generator outputs the clock signal according to a control code, wherein the control code is associated with a frequency of the clock signal. The storage device stores input data received from a DP source device by the DP output adapter, and transmits output data stored in the storage device to a DP sink device according to the clock signal. In addition, the controller controls the control code according to a data amount of the storage device.

### BACKGROUND OF THE INVENTION

### 1. FIELD OF THE INVENTION

The present invention is related to DisplayPort (DP) data transmission, and more particularly, to a DP output adapter and a method for controlling a clock signal of the DP output adapter.

### 2. DESCRIPTION OF THE PRIOR ART

When using a fourth-generation universal serial bus (USB4) cable to transmit DisplayPort (DP) signals, signal standards conversion is required; therefore, data transmission between devices at both ends of the USB4 cable needs to be controlled by each device’s clock signals. To ensure synchronization of the data transmission between the devices, a DP input adapter counts the number of clock signal periods at the input end of the USB4 cable over a 2²¹-nanoseconds cycle, and this counting result is transmitted to a DP output adapter via clock synchronization packets for clock signal calibration of the output end of the USB4 cable.

This calibration method has some issues. If the clock signal deviates from its original frequency during the 2²¹-nanosecond cycle, the DP output adapter needs to wait until the next clock synchronization packet is received before performing the clock signal calibration. This introduces the risk of data overflow or underflow in a buffering space of the DP output adapter. In addition, the buffering space of the DP output adapter may overflow or underflow due to a data reception speed being too high or too low. This overflow or underflow of the buffering space of the DP output adapter may cause display abnormalities (e.g. flickering or color deviation) or even failure to illuminate the display (e.g. resulting in a black screen).

Thus, there is a need for a novel clock calibration method and associated architecture, which can solve the problems mentioned above without introducing any side effect or in a way that is less likely to introduce side effects.

### SUMMARY OF THE INVENTION

An objective of the present invention is to provide a DisplayPort (DP) output adapter and a method for controlling a clock signal of the DP output adapter which can prevent the buffering space of the DP output adapter from encountering overflow or underflow.

At least one embodiment of the present invention provides a DP output adapter. The DP output adapter comprises a clock generator, a storage device and a controller, wherein the storage device is coupled to the clock generator, and the controller is coupled to the clock generator and the storage device. The clock generator is configured to output a clock signal according to a control code, wherein the control code is associated with a frequency of the clock signal. The storage device is configured to store input data received from a DP source device by the DP output adapter, and transmit output data stored in the storage device to a DP sink device according to the clock signal. In addition, the controller is configured to control the control code according to a data amount of the storage device.

At least one embodiment of the present invention provides a method for controlling a clock signal of a DP output adapter. The method comprises: utilizing a clock generator of the DP output adapter to output a clock signal according to a control code, wherein the control code is associated with a frequency of the clock signal; utilizing a storage device of the DP output adapter to store input data received from a DP source device by the DP output adapter; utilizing the storage device to transmit output data stored in the storage device to a DP sink device according to the clock signal; and utilizing a controller of the DP output adapter to control the control code according to a data amount of the storage device.

The DP output adapter and the associated method provided by the embodiments of the present invention can control the frequency of the clock signal output from the clock generator by monitoring a water level (e.g. the data amount mentioned above) of the buffering space of the DP output adapter (e.g. a storage space of the storage device mentioned above), and controlling a speed of outputting data from the DP output adapter, thereby preventing occurrence of overflow of underflow. In addition, the embodiments of the present invention will not greatly increase additional costs. Thus, the present invention can solve the problem of the related art without introducing any side effect or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a DisplayPort (DP) source device connected to a DP sink device via fourth-generation universal serial bus (USB4) connecting devices according to an embodiment of the present invention.

FIG. 2 is a diagram illustrating a DP output adapter according to an embodiment of the present invention.

FIG. 3 is a diagram illustrating a working flow of a method for controlling a clock signal of a DP output adapter according to an embodiment of the present invention.

FIG. 4 is a diagram illustrating a first control scheme of the method shown in FIG. 3 according to an embodiment of the present invention.

FIG. 5 is a diagram illustrating a second control scheme of the method shown in FIG. 3 according to an embodiment of the present invention.

FIG. 6 is a diagram illustrating a third control scheme of the method shown in FIG. 3 according to an embodiment of the present invention.

FIG. 7 is a diagram illustrating a working flow of a clock calibration method comprising the first control scheme shown in FIG. 4 and the third control scheme shown in FIG. 6 according to an embodiment of the present invention.

FIG. 8 is a diagram illustrating a working flow of a clock calibration method comprising the second control scheme shown in FIG. 5 and the third control scheme shown in FIG. 6 according to an embodiment of the present invention.

### DETAILED DESCRIPTION

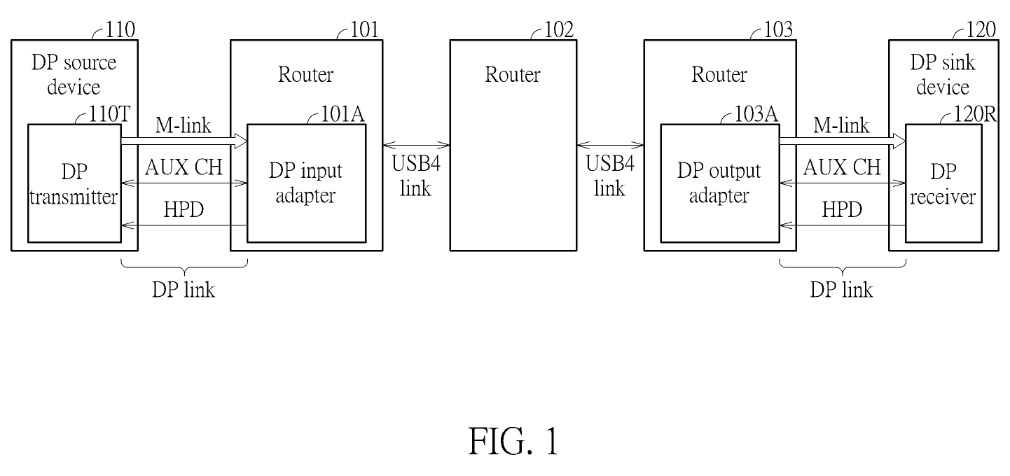

FIG. 1 is a diagram illustrating a DisplayPort (DP) source device 110 connected to a DP sink device 120 via fourth-generation universal serial bus (USB4) connecting devices such as routers 101, 102 and 103 according to an embodiment of the present invention. In this embodiment, the router 101 may be coupled to the DP source device 110 via a DP link, where a DP input adapter 101A within the router 101 may perform communication of a main link (labeled “M-link” in FIG. 1 for brevity), an auxiliary channel (labeled “AUX CH” in FIG. 1 for brevity) and a hot-plug detection (labeled “HPD” in FIG. 1 for brevity) with a DP transmitter 110T within the DP source device 110 via the DP link. Similarly, the router 103 may be coupled to the DP sink device 120 via a DP link, where the DP output adapter 103A within the router 103 may perform communication of a main link (labeled “M-link” in FIG. 1 for brevity), an auxiliary channel (labeled “AUX CH” in FIG. 1 for brevity) and a hot-plug detection (labeled “HPD” in FIG. 1 for brevity) with the DP receiver 120R within the DP sink device 120 via the DP link. In addition, the router 102 may be coupled between the routers 101 and 103 via USB4 links. Specifically, the router 101 (e.g. the DP input adapter 101A therein) may convert source data transmitted by the DP source device 110 (e.g. the DP transmitter 110T therein) from a DP format into a USB4 format, to allow the source data be transmitted to the router 103 via the router 102 (e.g. via a USB4 cable), and the router 103 (e.g. the DP output adapter 103A therein) may convert the source data transmitted by the router 102 from the USB4 format into the DP format, to allow the DP sink device 120 (e.g. the DP receiver 120R therein) to obtain the source data via the DP link.

As the process of transmitting the source data from the DP source device 110 to the DP sink device 120 involves different types of transmission interfaces, such as the DP link and USB4 link, data transmission of the DP transmitter 110T and data reception of the DP receiver 120R are executed based on respective clock signals. Thus, when the clock signal utilized in the data transmission of the DP transmitter 110T and the clock signal utilized in the data reception of the DP receiver 120R are not synchronized (e.g. having different frequencies), speed of the data transmission of the DP transmitter 110T is not the same as speed of the data reception of the DP receiver 120R, which makes a water level (e.g. data amount) of a data buffering space within the DP output adapter 103A change, resulting in risk of overflow (e.g. data overflow) or underflow (e.g. data underflow). In order to reduce the risk of overflow or underflow of the data buffering space of the DP output adapter 103A, the present invention can monitor the water level of the data buffering space within the DP output adapter 103A in a real-time manner, and accordingly control speed of the DP output adapter 103A outputting data and speed of the DP receiver 120R receiving data.

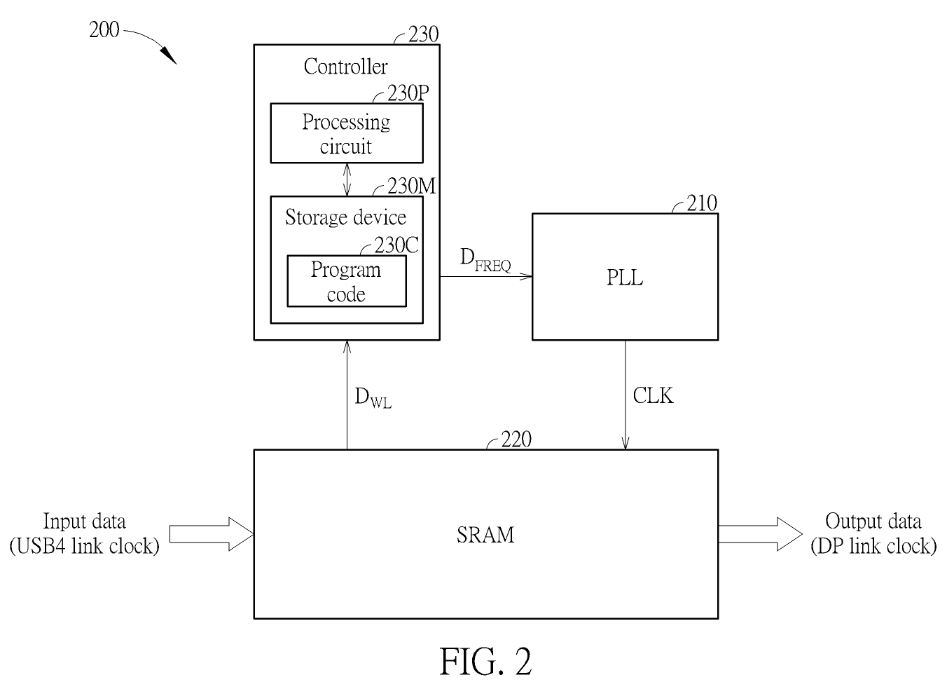

FIG. 2 is a diagram illustrating a DP output adapter 200 according to an embodiment of the present invention, where the DP output adapter 200 may be an example of the DP output adapter 103A shown in FIG. 1. As shown in FIG. 2, the DP output adapter 200 may comprise a clock generator such as a phase locked loop (PLL) 210, a storage device such as a static random access memory (SRAM) 220, and a controller 230, where the SRAM 220 is coupled to the PLL 210, and the controller 230 is coupled to the PLL 210 and the SRAM 220. In this embodiment, the PLL 210 is configured to output a clock signal CLK according to a control code D_{FREQ}, where the control code D_{FREQ} corresponds to a frequency of the clock signal CLK. A storage space of the SRAM 220 may be an example of the data buffering space within the DP output adapter 103A, where the SRAM 220 is configured to store input data (e.g. source data output from the DP source device 110, which is obtained via the routers 101 and 102 shown in FIG. 1) received from a DP source device (e.g. the DP source device 110 shown in FIG. 1) by the DP output adapter 200, and transmit output data stored in the SRAM 220 to a DP sink device (e.g. the DP sink device 120 shown in FIG. 1) according to the clock signal CLK. More particularly, the controller 230 is configured to control (e.g. generate) the control code D_{FREQ} according to a data amount such as a water level of the SRAM 220. For example, a water level code D_{WL} may be arranged to represent the data amount of the SRAM 220, and the controller 230 may read the water level code D_{WL} from the SRAM 220, in order to control the control code D_{FREQ} according to the water level code D_{WL}.

In this embodiment, operations of the controller 230 may be implemented with firmware. For example, the controller 230 may comprise a processing circuit 230P and a storage device 230M, where the storage device 230M may store a program code 230C, and the processing circuit 230P may execute the operations of the controller 230 according to the program code 230C. In some embodiments, the operations of the controller 230 may be implemented with hardware (e.g. respective operations of the controller 230 may be implemented with corresponding logic circuits).

In this embodiment, the data amount such as the water level of the SRAM 220 may be increased in response to receiving the input data from the DP source device 110, and may be decreased in response to transmitting the output data to the DP sink device 120, where speed of receiving the input data via the USB4 link is controlled by a frequency of a clock signal of the USB4 (labeled “USB4 link clock” in FIG. 2 for better comprehension), and speed of transmitting the output data via the DP link is controlled by a frequency of a clock signal of the DP link (labeled “DP link clock” in FIG. 2 for better comprehension). More particularly, the clock signal CLK output from the PLL 210 may be taken as the clock signal of the DP link. Thus, the speed of transmitting the output data to the DP sink device 120 is controlled by the frequency of the clock signal CLK.

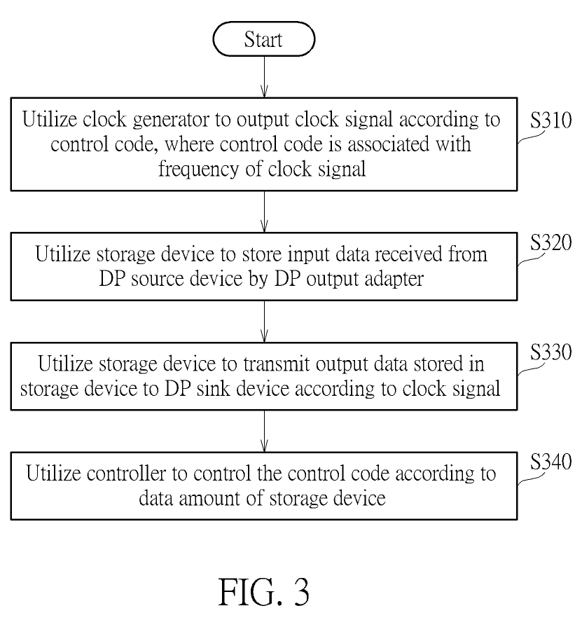

FIG. 3 is a diagram illustrating a working flow of a method for controlling a clock signal (e.g. the clock signal CLK shown in FIG. 2) of a DP output adapter (e.g. the DP output adapter 200 shown in FIG. 2) according to an embodiment of the present invention. It should be noted that the working flow shown in FIG. 3 is for illustrative purposes only, and is not meant to be a limitation of the present invention. For example, one or more steps may be added, deleted or modified in the working flow shown in FIG. 3. In addition, if a same result can be obtained, these steps do not have to be executed in the exact order shown in FIG. 3.

In Step S310, the DP output adapter may utilize a clock generator therein to output a clock signal according to a control code, where the control code is associated with a frequency of the clock signal.

In Step S320, the DP output adapter may utilize a storage device therein to store input data received from a DP source device by the DP output adapter.

In Step S330, the DP output adapter may utilize the storage device to transmit output data stored in the storage device to a DP sink device according to the clock signal.

In Step S340, the DP output adapter may utilize a controller therein to control the control code according to a data amount of the storage device.

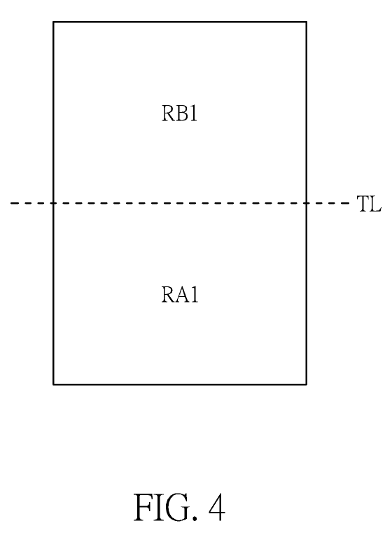

FIG. 4 is a diagram illustrating a first control scheme of the method shown in FIG. 3 according to an embodiment of the present invention. In this embodiment, the controller 230 may determine whether to adjust the frequency of the clock signal CLK by adjusting the control code D_{FREQ} according to whether the data amount (e.g. the water level code D_{WL}) of the SRAM 220 is greater than a target value TL. For example, when the data amount such as the water level code D_{WL} is greater than the target value TL, the water level code D_{WL} falls in a region RB1 shown in FIG. 4, and the controller 230 may increase the frequency of the clock signal CLK by adjusting the control code D_{FREQ} (e.g. by increasing the speed of transmitting the output data to the DP sink device 120 for decreasing the data amount). When the data amount such as the water level code D_{WL} is less than the target value TL, the water level code D_{WL} falls in a region RA1 shown in FIG. 4, and the controller 230 may decrease the frequency of the clock signal CLK by adjusting the control code D_{FREQ} (e.g. by decreasing the speed of transmitting the output data to the DP sink device 120 for increasing the data amount). With the first control scheme shown in FIG. 4, the controller 230 may maintain the data amount of the SRAM 220 at the target value (or approaching the target value) by properly adjusting the frequency of the clock signal CLK (e.g. by adjusting the speed of transmitting the output data to the DP sink device 120), to thereby prevent the occurrence of overflow or underflow.

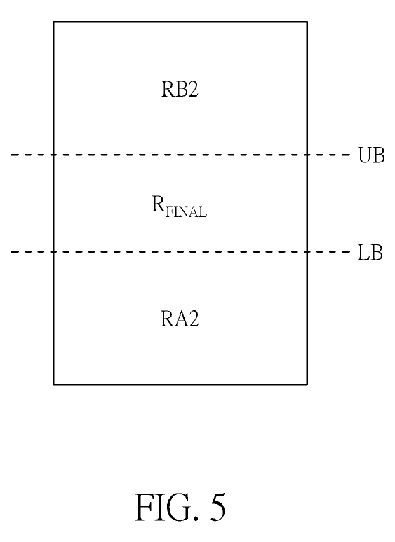

FIG. 5 is a diagram illustrating a second control scheme of the method shown in FIG. 3 according to an embodiment of the present invention. In this embodiment, the controller 230 may determine whether to adjust the frequency of the clock signal CLK by adjusting the control code D_{FREQ} according to whether the data amount (e.g. the water level code D_{WL}) of the SRAM 220 is in a target region R_{FINAL} between an upper bound value UB and a lower bound value LB. For example, when the data amount such as the water level code D_{WL} is greater than the upper bound value UB, the water level code D_{WL} falls in a region RB2 shown in FIG. 5, and the controller 230 may increase the frequency of the clock signal CLK (e.g. increasing the speed of transmitting the output data to the DP sink device 120 for decreasing the data amount) by adjusting the control code D_{FREQ}. When the data amount such as the water level code D_{WL} is less than the lower bound value LB, the water level code D_{WL} falls in a region RA2 shown in FIG. 5, and the controller 230 may decrease the frequency of the clock signal CLK by adjusting the control code D_{FREQ} (e.g. decreasing the speed of transmitting the output data to the DP sink device 120 for increasing the data amount). With the second control scheme shown in FIG. 5, the controller 230 may maintain the data amount of the SRAM 220 in the target region R_{FINAL} by properly adjusting the frequency of the clock signal CLK (e.g. by adjusting the speed of transmitting the output data to the DP sink device 120), to thereby prevent the occurrence of overflow or underflow.

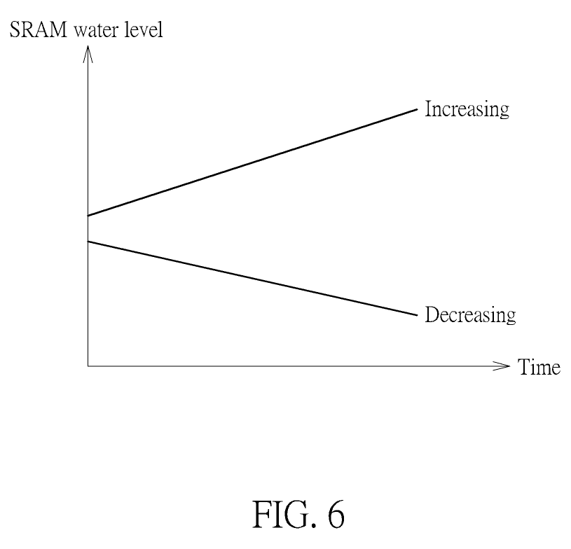

FIG. 6 is a diagram illustrating a third control scheme of the method shown in FIG. 3 according to an embodiment of the present invention. In this embodiment, the controller 230 may determine whether to adjust the frequency of the clock signal CLK by adjusting the control code D_{FREQ} according to a changing trend of the data amount of the SRAM 220. For example, when the changing trend of the data amount such as the water level code D_{WL} (e.g. a SRAM water level shown in FIG. 6) is increasing (e.g. a present value of the water level code D_{WL} is greater than a previous value of the water level code D_{WL}), the controller 220 may increase the frequency of the clock signal CLK (e.g. increasing the speed of transmitting the output data to the DP sink device 120 for lowering an increasing speed of the data amount) by adjusting the control code D_{FREQ}. When the changing trend of the data amount such as the water level code D_{WL} (e.g. the SRAM water level shown in FIG. 6) is decreasing (e.g. the present value of the water level code D_{WL} is less than the previous value of the water level code D_{WL}), the controller may decrease the frequency of the clock signal CLK (e.g. decreasing the speed of transmitting the output data to the DP sink device 120 for lowering a decreasing speed of the data amount) by adjusting the control code D_{FREQ}. With the third control scheme shown in FIG. 6, the controller 230 may minimize changing speed of the data amount (e.g. making the data amount unchanged) of the SRAM 220 by properly adjusting the frequency of the clock signal CLK (e.g. by adjusting the speed of transmitting the output data to the DP sink device 120), to thereby prevent the occurrence of overflow or underflow.

It should be noted that the first control scheme, the second control scheme and the third control scheme mentioned above may be combined with one another to further improve control of the data amount of the SRAM 220.

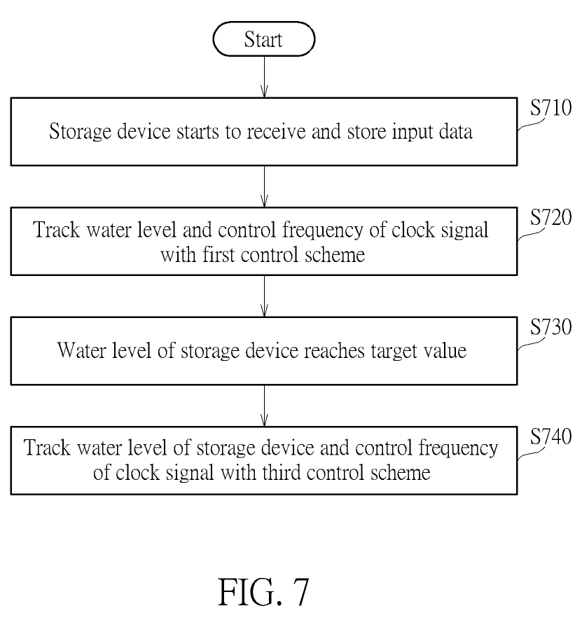

FIG. 7 is a diagram illustrating a working flow of a clock calibration method comprising the first control scheme shown in FIG. 4 and the third control scheme shown in FIG. 6 according to an embodiment of the present invention. It should be noted that the working flow shown in FIG. 7 is for illustrative purposes only, and is not meant to be a limitation of the present invention. For example, one or more steps may be added, deleted or modified in the working flow shown in FIG. 7.

In Step S710, the storage device (e.g. the SRAM 220) within the DP output adapter 200 starts to receive and store the input data obtained via the USB4 link.

In Step S720, the controller 230 within the DP output adapter 200 tracks the water level (e.g. the water level code D_{WL}) of the storage device and controls the frequency of the clock signal CLK with the first control scheme shown in FIG. 4 first.

In Step S730, the water level (e.g. the water level code D_{WL}) of the storage device reaches the target value TL due to control of the first control scheme.

In Step S740, after the water level (e.g. the water level code D_{WL}) of the storage device reaches the target value TL, the controller 230 within the DP output adapter 200 then tracks the water level (e.g. the water level code D_{WL}) of the storage device and controls the frequency of the clock signal CLK with the third control scheme shown in FIG. 6.

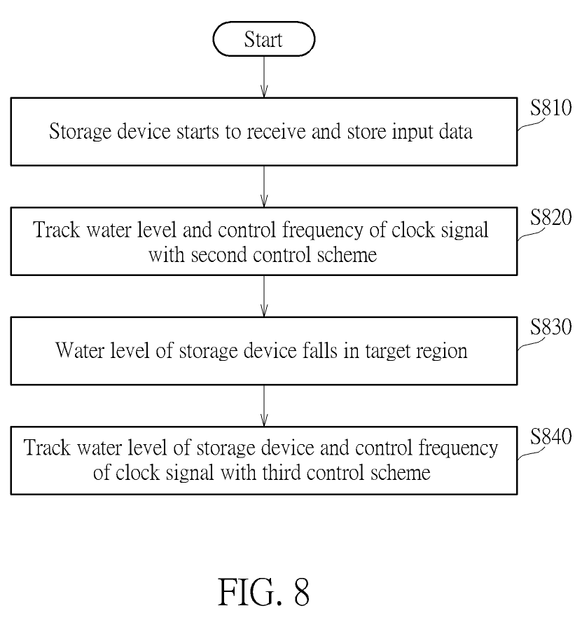

FIG. 8 is a diagram illustrating a working flow of a clock calibration method comprising the second control scheme shown in FIG. 5 and the third control scheme shown in FIG. 6 according to an embodiment of the present invention. It should be noted that the working flow shown in FIG. 8 is for illustrative purposes only, and is not meant to be a limitation of the present invention. For example, one or more steps may be added, deleted or modified in the working flow shown in FIG. 8.

In Step S810, the storage device (e.g. the SRAM 220) within the DP output adapter 200 starts to receive and store the input data obtained via the USB4 link.

In Step S820, the controller 230 within the DP output adapter 200 tracks the water level (e.g. the water level code D_{WL}) of the storage device and first controls the frequency of the clock signal CLK with the second control scheme shown in FIG. 5.

In Step S830, the water level (e.g. the water level code D_{WL}) of the storage device falls in the target region R_{FINAL} due to control of the second control scheme.

In Step S840, after the water level (e.g. the water level code D_{WL}) of the storage device falls in the target region R_{FINAL}, the controller 230 within the DP output adapter 200 then tracks the water level (e.g. the water level code D_{WL}) of the storage device and controls the frequency of the clock signal CLK with the third control scheme shown in FIG. 6.

To summarize, the DP output adapter and the method provided by the embodiments of the present invention can monitor the data amount of the buffering space therein, and accordingly control the speed of outputting data, thereby maintaining the data amount of the buffering space at a target value or within a target range. As a result, even if a frequency of a DP link clock of the DP transmitter at the front-end varies and a DP clock synchronization packet is unable to be immediately transmitted, the DP output adapter can still adjust a frequency of a DP link clock of the DP receiver in response to the data amount of the buffering space therein, to thereby prevent the occurrence of overflow or underflow. In addition, the embodiments of the present invention will not greatly increase additional costs. Thus, the present invention can solve the problem of the related art without introducing any side effect or in a way that is less likely to introduce side effects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A DisplayPort (DP) output adapter, comprising:
a clock generator, configured to output a clock signal according to a control code, wherein the control code is associated with a frequency of the clock signal;
a storage device, coupled to the clock generator, configured to store input data received from a DP source device by the DP output adapter, and transmit output data stored in the storage device to a DP sink device according to the clock signal; and
a controller, coupled to the clock generator and the storage device, configured to control the control code according to a data amount of the storage device.

2. The DP output adapter of claim 1, wherein the data amount of the storage device is increased in response to receiving the input data from the DP source device and is decreased in response to transmitting the output data to the DP sink device, and a speed of transmitting the output data to the DP sink device is controlled by the frequency of the clock signal.

3. The DP output adapter of claim 2, wherein the controller determines whether to adjust the frequency of the clock signal by adjusting the control code according to whether the data amount is greater than a target value.

4. The DP output adapter of claim 3, wherein:
when the data amount is greater than the target value, the controller increases the frequency of the clock signal by adjusting the control code; and
when the data amount is less than the target value, the controller decreases the frequency of the clock signal by adjusting the control code.

5. The DP output adapter of claim 2, wherein the controller determines whether to adjust the frequency of the clock signal by adjusting the control code according to whether the data amount is in a target region between an upper bound value and a lower bound value.

6. The DP output adapter of claim 5, wherein:
when the data amount is greater than the upper bound value, the controller increases the frequency of the clock signal by adjusting the control code; and
when the data amount is less than the lower bound value, the controller decreases the frequency of the clock signal by adjusting the control code.

7. The DP output adapter of claim 2, wherein the controller determines whether to adjust the frequency of the clock signal by adjusting the control code according to a changing trend of the data amount.

8. The DP output adapter of claim 7, wherein:
when the changing trend of the data amount is increasing, the controller increases the frequency of the clock signal by adjusting the control code; and
when the changing trend of the data amount is decreasing, the controller decreases the frequency of the clock signal by adjusting the control code.

9. A method for controlling a clock signal of a DisplayPort (DP) output adapter, comprising:
utilizing a clock generator of the DP output adapter to output a clock signal according to a control code, wherein the control code is associated with a frequency of the clock signal;
utilizing a storage device of the DP output adapter to store input data received from a DP source device by the DP output adapter;
utilizing the storage device to transmit output data stored in the storage device to a DP sink device according to the clock signal; and
utilizing a controller of the DP output adapter to control the control code according to a data amount of the storage device.

10. The method of claim 1, wherein the data amount of the storage device is increased in response to receiving the input data from the DP source device and is decreased in response to transmitting the output data to the DP sink device, and a speed of transmitting the output data to the DP sink device is controlled by the frequency of the clock signal.

11. The method of claim 10, wherein utilizing the controller of the DP output adapter to control the control code according to the data amount of the storage device comprises:
utilizing the controller to determine whether to adjust the frequency of the clock signal by adjusting the control code according to whether the data amount is greater than a target value.

12. The method of claim 11, wherein utilizing the controller to determine whether to adjust the frequency of the clock signal by adjusting the control code according to whether the data amount is greater than the target value comprises:
in response to the data amount being greater than the target value, utilizing the controller to increase the frequency of the clock signal by adjusting the control code.

13. The method of claim 11, wherein utilizing the controller to determine whether to adjust the frequency of the clock signal by adjusting the control code according to whether the data amount is greater than the target value comprises:
in response to the data amount being less than the target value, utilizing the controller to decrease the frequency of the clock signal by adjusting the control code.

14. The method of claim 10, wherein utilizing the controller of the DP output adapter to control the control code according to the data amount of the storage device comprises:
utilizing the controller to determine whether to adjust the frequency of the clock signal by adjusting the control code according to whether the data amount is in a target region between an upper bound value and a lower bound value.

15. The method of claim 14, wherein utilizing the controller to determine whether to adjust the frequency of the clock signal by adjusting the control code according to whether the data amount is in the target region between the upper bound value and the lower bound value comprises:
in response to the data amount being greater than the upper bound value, utilizing the controller to increase the frequency of the clock signal by adjusting the control code.

16. The method of claim 14, wherein utilizing the controller to determine whether to adjust the frequency of the clock signal by adjusting the control code according to whether the data amount is in the target region between the upper bound value and the lower bound value comprises:
in response to the data amount being less than the lower bound value, utilizing the controller to decrease the frequency of the clock signal by adjusting the control code.

17. The method of claim 10, wherein utilizing the controller of the DP output adapter to control the control code according to the data amount of the storage device comprises:
utilizing the controller to determine whether to adjust the frequency of the clock signal by adjusting the control code according to a changing trend of the data amount.

18. The method of claim 17, wherein utilizing the controller to determine whether to adjust the frequency of the clock signal by adjusting the control code according to the changing trend of the data amount comprises:
in response to the changing trend of the data amount being increasing, utilizing the controller to increase the frequency of the clock signal by adjusting the control code.

19. The method of claim 17, wherein utilizing the controller to determine whether to adjust the frequency of the clock signal by adjusting the control code according to the changing trend of the data amount comprises:
in response to the changing trend of the data amount being decreasing, utilizing the controller to decrease the frequency of the clock signal by adjusting the control code.
